(19) United States
(12) Patent Application Publication
(10) Pub. No.: US 2007/0139476 A1
(43) Pub. Date: Jun. 21, 2007

(54) Curable inkjet ink

(76) Inventors: Nathaniel Reed Schwartz, Newark, DE (US); Robert Paul Held, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/637,452

(22) Filed: Dec. 12, 2006

Related U.S. Application Data
(60) Provisional application No. 60/750,730, filed on Dec. 15, 2005.

(51) Int. Cl. B41J 2/14

(52) U.S. Cl. 347/52; 522/71

(57) ABSTRACT

The present invention pertains to a radiation curable inkjet ink and more particularly to radiation curable ink comprising a specified surfactant mixture which provides compatibility with a wide range of substrates.

This application claims priority under 35 U.S.C. §119 from U.S. Provisional Application Ser. No. 60/750,730, filed Dec. 15, 2005.

### BACKGROUND OF THE INVENTION

The present invention pertains to a radiation curable inkjet ink and, more particularly, to radiation curable ink comprising a specified surfactant mixture which provides compatibility with a wide range of substrates.

Inkjet imaging techniques have become very popular in commercial and consumer applications. Ink jet printers operate by ejecting ink onto a receiving substrate in controlled patterns of closely spaced ink droplets. By selectively regulating the pattern of ink droplets, ink jet printers can produce a wide variety of printed features, including text, graphics, images, holograms, and the like. Moreover, ink jet printers are capable of forming printed features on a wide variety of substrates, as well as three-dimensional objects in applications such as rapid prototyping.

Inkjet inks must meet stringent performance requirements in order for the inks to be appropriately jettable and for the resultant printed features to have the desired mechanical, chemical, visual and durability characteristics. In particular, inks must have relatively low viscosity when jetted, yet must be able to form accurate, durable images on the desired receiving substrate. For example, a typical ink will have a viscosity in the range of 3 to 30 centipoise at the jetting temperature. The low viscosity, however, poses a substantial challenge to achieving printed features with good mechanical and durability characteristics.

Inkjet inks with polymerizable diluent have been developed for applications where dealing with conventional aqueous-based or solvent-based vehicle is inconvenient. The diluent serves as the ink vehicle but is cured rapidly to form a polymer film so that no drying is required. Applications for curable inks involve imaging on a variety of substrates ranging from absorbent to non-absorbent and including paper, glass, plastic, wood and metal.

Radiation curable compositions currently known tend to be suitable for, and have proper dot gain on, only a limited range of substrates. Dot gain refers to the degree to which a jetted ink droplet spreads out upon application to a substrate. If the droplet spreads too much on the substrate, poor edge definition and inter-color bleed is observed. On the other hand, if a droplet spreads insufficiently, poor image appearance is obtained. Dot gain characteristics depend upon a number of factors including the ink jet composition, the nature of the substrate, the substrate temperature and the interfacial tension between the ink and the substrate. Some inks show favorable dot gain characteristics on some substrates, but not on others. Preferably, a single ink formulation should be useful wide variety of substrates.

Radiation curable inkjet inks with polymerizable diluent are disclosed, for example, in WO02/061001, WO05/030881, U.S. Pat. No. 6,685,311 and U.S. Pat. No. 6,913,352.

Radiation curable inkjet inks with a polymerizable silicone derivative as part of the polymerizable diluent are disclosed, for example, in U.S. Pat. No. 6,593,390 and WO05/047405. The polymerizable silicone derivative, such as silicone acrylate, can modify the surface tension of the ink.

An ink jettable, radiation curable, overprint composition is disclosed in US2005/0249895. The composition comprises polymerizable diluent and a surfactant, such as a polyether modfied polydimethylsiloxane or a fluorosurfactant, to reduce the surface tension.

A radiation curable inkjet ink free of unreactive volatile organic compounds comprising polymerizable diluent and poly(alkylene oxide) modified poly(dimethyl siloxane) surfactant is disclosed in WO05/030879.

All of the above-referenced disclosures are incorporated by reference herein for all purposes as if fully set forth.

There is a still need for radiation curable inks with good dot gain and image appearance on a broad range of substrate types.

### SUMMARY OF THE INVENTION

In one aspect, the present invention pertains to a radiation curable inkjet ink composition comprising a polymerizable vehicle and a surfactant mixture, wherein the surfactant mixture comprises at least one fluorinated surfactant (preferably about 0.1% to about 4.0% by weight, based on total ink weight) and at least one acetylenic diol surfactant (preferably about 0.1% to about 4.0% by weight, based on total ink weight).

In one embodiment, the polymerizable vehicle comprises a mixture of mono-functional and multi-functional polymerizable monomers.

In another embodiment the ink further comprises a colorant, preferably a pigment colorant stably dispersed in the polymerizable vehicle.

In yet another embodiment the ink further comprises any one or all of a photosensitizer, a photosynergist and/or a photoinitiator.

In another aspect, the present invention pertains to a method for ink jet printing, comprising the steps of:

(a) providing an ink jet printer that is responsive to digital data signals;

(b) loading the printer with a substrate to be printed;

(c) loading the printer with a radiation curable inkjet ink as set forth above; and

(d) printing onto the substrate using said inkjet ink, in response to the digital data signals, and forming thereby a printed article.

In one embodiment, the inventive method further comprising the step of exposing the printed article to radiation suitable for curing the ink printed thereon. The radiation is preferably ultraviolet light.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### DETAILED DESCRIPTION OF THE PREFERRED EMBODIMENTS

Surfactant Mixture

The prescibed surfactant comprises a mixture of a fluorosurfactant and an acetylenic diol surfactant.

Fluorinated surfactants include surfactants represented by the following formula:
(R(f)Q)ₙA
wherein R(f) is a perfluoroalkyl group having 6 to 22 carbon atoms, Q is a divalent bridging group, A is a water-soluble group, and n is 1 or 2.

The bridging Q group may be a diradical of an alkyl, aryl or alkylaryl group containing less than 10 carbon atoms, and may contain heteroatoms such as S, O and N. The linkage between the bridging Q group and the A group may be ether, ester, amide or sulfoamido, provided it is stable under the conditions of use.

The A group may be selected, for example, from —(OCH₂CH₂)ₓOH, wherein x is 1 to 12; —COOM and —SO₃M, wherein M is hydrogen, ammonium, amine or an alkali metal such as lithium, sodium or potassium; —PO₄(Z)_{y}, wherein y is 1-2 and Z is hydrogen, ammonium, amine or an alkali metal such as lithium, sodium or potassium; —NR₃X, wherein R₃ is an alkyl group of 1 to 4 carbon atoms and X is an anionic counterion selected from the group consisting of halides, acetates, sulfonates and zwitterionic groups. Preferably, the A group is an ethylene oxide group of no greater than 8 to 9 monomer units.

Suitable fluorinated surfactants include those available from E. I. du Pont de Nemours and Company (Wilmington, Del.) under the tradename Zonyl® and from 3M Company (Minneapolis, Minn.) under the tradename Fluorad®), and may be used alone or in any combinations. The specific surfactant(s) selected will vary with other components in the ink and the properties of the ink printed adjacent to it. It is important that the ionic character of the selected fluorinated surfactant be compatible with other components in the inks to avoid precipitation or flocculation. In one embodiment, the fluorinated surfactant should be non-ionic.

Some examples of suitable fluorinated surfactants are shown in the following table:

| R(f) | Q | A | n |
|---|---|---|---|
| F(CF₂CF₃)₃₋₈ | CH₂CH₂SCH₂CH₂ | CO₂Li (a) | 1 |
| F(CF₂CF₂)₃₋₈ | CH₂CH₂ | PO₄(NH₄)₂ (a) | 1 |
| F(CF₂CF₃)₃₋₈ | CH₂CH₂ | PO₄NH₄ (a) | 2 |
| F(CF₂CF₃)₃₋₈ | CH₂CH₂ | (OCH₂CH₂)ₓOH (b) | 1 |

(a) Counter ions other than lithium and ammonium are also useful
(b) x is 1-10

The selected concentration will vary with the ink system, efficiency of the fluorinated surfactant, properties of companion ink(s), and the intended media. Generally, sufficient fluorinated surfactant will be added to provide adequate wetting of hydrophobic media surfaces. Preferred fluorinated surfactants include fluoroalkyl alcohol substituted monoether with polyethylene glycol, and telomer B monoether with polyethylene glycol.

Acetylenic diol surfactants are characterized by the 2-butyne-1,4-diol nucleus. The alcohol groups are optionally ethoxylated and the alkyne nucleus is further substituted with alkyl groups. An exemplary acetylenic diol surfactant is depicted by the following structure: 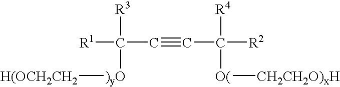
wherein R¹ are R² are independently branched or linear alkyls having 3 to 12 carbons, R³ are R⁴ are independently hydrogen or methyl, x and y are integers, and x+y is 0 to about 16.

Commercial examples include the Surfynol®) and Dynol™ series of surfactants from Air Products (Allentown, Pa., USA). Preferred in some embodiments are Surfynol®) 104 and Dynol™ 604, which are available as concentrated surfactant with substantially no solvent.

Surfynol® 104 can be depicted by the following structure:

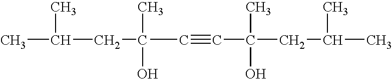

The mixture of surfactants is typically present in the amount of from about 2 wt % to about 6 wt %, and preferably from about 2.5 wt % to about 4.5 wt %, based on the total weight of the ink composition. The surfactants in the mixture are chosen such that the mixture provides sufficient wetting of hydrophobic surfaces.

Polymerizable Vehicle

“Vehicle” is a general term to refer to the liquid medium, or carrier, for the colorant and/or any additives present in an ink. A “polymerizable” vehicle is a vehicle comprised of reactive liquid components (diluents) that can be polymerized to form a polymer film. Herein the term diluent is often used in place of vehicle to emphasize the difference between a reactive vehicle/diluent and the more traditional nonreactive aqueous- and solvent-based vehicles.

The reactive liquid components include monofunctional and multifuntional (di-, tri- or higher) functional monomers. By mono-, di-, tri- and higher functional material is meant compounds having, respectively, one, two, three or more functional groups (such as unsaturated carbon-carbon and/or epoxy) which are polymerizable by radiation, especially but not exclusively ultraviolet light. A preferred vehicle comprises a mixture of monofunctional and multifunctional monomers. In one embodiment, the monomers are selected from acrylate, methacrylate and vinylether derivatives.

Inks comprising the prescribed vehicle may be cured (polymerized) by any suitable form of electromagnetic radiation, including electron beam, visible light or, more preferably, ultraviolet light.

Monofunctional polymerizable monomers include, for example: styrene, alpha-methylstyrene, substituted styrene, vinyl esters, vinyl ethers, N-vinyl-2-pyrrolidone, (meth)acrylamide, N-substituted (meth)acrylamide, octyl(meth)acrylate, nonylphenol ethoxylate(meth)acrylate, isononyl(meth)acrylate, isobornyl(meth)acrylate, 2-(2-ethoxyethoxy)ethyl(meth)acrylate, 2-ethylhexyl(meth)acrylate, lauryl(meth)acrylate, β-carboxyethyl(meth)acrylate, isobutyl(meth)acrylate, cycloaliphatic epoxide, α-epoxide, 2-hydroxyethyl(meth)acrylate, (meth)acrylonitrile, maleic anhydride, itaconic acid, isodecyl(meth)acrylate, dodecyl(meth)acrylate, n-butyl(meth)acrylate, methyl(meth)acrylate, hexyl(meth)acrylate, (meth)acrylic acid, N-vinylcaprolactam, stearyl(meth)acrylate, hydroxy functional caprolactone ester(meth)acrylate, isooctyl(meth)acrylate, hydroxyethyl(meth)acrylate, hydroxymethyl(meth) acrylate, hydroxypropyl(meth)acrylate, hydroxyisopropyl(meth)acrylate, hydroxybutyl(meth)acrylate, hydroxyisobutyl(meth)acrylate, tetrahydrofurfuryl(meth)acrylate, combinations of these, and the like.

A preferred monofunctional polymerizable monomer is a linear alkyl acrylate selected from n-octyl acrylate, n-nonyl acrylate, n-decyl acrylate and any combination thereof.

Representative multifunctional monomers include: hexanediol diacrylate, trimethylolpropane triacrylate, pentaerythritol triacrylate, polyethyleneglycol diacrylate (for example, tetraethyleneglycol diacrylate), dipropyleneglycol diacrylate, tri(propylene glycol)triacrylate, neopentylglycol diacrylate, bis(pentaerythritol)hexa-acrylate, and the acrylate esters of ethoxylated or propoxylated glycols and polyols, for example, propoxylated neopentyl glycol diacrylate, and ethoxylated trimethylolpropane triacrylate. Also included are: triethylene glycol divinyl ether, diethylene glycol divinyl ether, 1,4-cyclohexanedimethanol divinyl ether, and ethylene glycol monovinyl ether.

A preferred difunctional polymerizable monomer is ethoxylated 1,6-hexanediol diacrylate, such as represented by the following formula:
CH₂═CH₂C(O)—O—(CH₂CH₂O—)_{y}(CH₂)₆—(OCH₂CH₂)_{z}O—(O)CH₂═CH₂
wherein y and z are integers, and the moles of ethoxylation (y+z) per molecule is on average at least about one and generally less than about ten. In a preferred embodiment, y+z is on average between about one and about three, and more preferably on average about two.

A preferred trifunctional polymerizable monomer is propoxylated trimethylolpropane triacrylate, such as represented by the following formula: 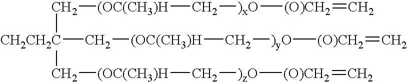
wherein x, y and z are integers, and the moles of propoxylation (x+y+z) per molecule is on average at least about one and generally less than about ten. In a preferred embodiment, x+y+z is on average between about two and about four, and more preferably on average about three.

The vehicle often comprises a mixture of polymerizable components to achieve a balance of desirable performance criteria such as low viscosity, fast cure speed and durable cured films. Multifunctional monomers can increase cure speed, but tend to be very viscous. Monofunctional monomers can have lower viscosity, but tend to give soft cured films. High Tg components can improve film hardness and abrasion resistance, but too much can cause the film to be brittle and shrink.

Typically, the total of all mono-functional and multi-functional polymerizable monomers amounts to at least about 65% by weight of the total weight of ink.

If desired, the vehicle can comprise minor amounts (less than about 10% by weight of the total ink) of non-reactive solvent, in particular organic solvent. Organic solvents useful in inkjet inks are generally well known and include, for example, alkanes, aromatics, alcohols, ketones, keto-alcohols, ethers, glycols and the like. However, the polymerizable vehicle generally requires no solvent and in a preferred embodiment solvent (nonpolymerizable diluent) is avoided (substantially free of nonpolymerizable solvents). However, some solvent may be present incidentally through use of certain additives that are less 100% active. In one embodiment, nonpolymerizable diluent (organic solvent) is less than about 3 wt %, and preferably less than 1 wt %, based on the total weight of ink.

Colorant

Colored inks comprise one or more colorants. The colorant can be any suitable colorant but from the standpoint of resistance to fade in outdoor applications, pigment colorants are preferred.

Pigments by definition are substantially insoluble in the vehicle and, in order to be used, must be stabilized to dispersion. Pigments can be stabilized to dispersion by separate dispersing agents, such as polymeric dispersants or surfactants. Alternatively, a pigment surface can be modified to chemically attach dispersibility-imparting groups and thereby form a so-called “self-dispersible” or “self-dispersing” pigment (hereafter “SDP(s)”), which is stable to dispersion without separate dispersant. “Stably dispersed” means that the pigment particles are uniformly distributed and reasonably resistant to settling, flocculation and particle growth (ripening) under normal use conditions.

For dispersant-stabilized pigment dispersions, the choice and amount of dispersant will generally depend upon the nature and concentration of the pigment, and composition of the diluent. Examples of suitable materials may be found among dispersants sold under the trade names of Solsperse™ (Noveon), EFKA and BYK® (Byk Chemie). Mixtures of dispersants and mixtures of one or more dispersants with one or more dispersant synergists may be employed. Detailed teaching of pigment milling and millbase let down can be found, for example, in Paint Flow and Pigment Dispersion, Temple C. Patton, Wiley lnterscience 1979 (ISBN #0-471-03272).

Pigments useful in the invention may be organic or inorganic. Suitable inorganic pigments include carbon black and titania (TiO₂), while suitable organic pigments include phthalocyanines, anthraquinones, perylenes, carbazoles, monoazo- and disazobenzimidazolones, isoindolinones, monoazonaphthols, diarylidepyrazolones, rhodamines, indigoids, quinacridones, diazopyranthrones, dinitranilines, pyrazolones, dianisidines, pyranthrones, tetrachloroisoindolinones, dioxazines, monoazoacrylides and anthrapyrimidines.

Useful organic pigments include those described in The Colour Index, Vols. 1-8, Society of Dyers and Colourists, Yorkshire, England. Nonlimiting examples included those having the following designations: Pigment Blue 1, Pigment Blue 15, Pigment Blue 15:1, Pigment Blue 15:2, Pigment Blue 15:3, Pigment Blue 15:4, Pigment Blue 15:6, Pigment Blue 16, Pigment Blue 24 and Pigment Blue 60; Pigment Brown 5, Pigment Brown 23 and Pigment Brown 25; Pigment Yellow 3, Pigment Yellow 14, Pigment Yellow 16, Pigment Yellow 17, Pigment Yellow 24, Pigment Yellow 65, Pigment Yellow 73, Pigment Yellow 74, Pigment Yellow 83, Pigment Yellow 95, Pigment Yellow 97, Pigment Yellow 108, Pigment Yellow 109, Pigment Yellow 110, Pigment Yellow 113, Pigment Yellow 128, Pigment Yellow 129, Pigment Yellow 138, Pigment Yellow 139, Pigment Yellow 150, Pigment Yellow 151, Pigment Yellow 154, Pigment Yellow 155, Pigment Yellow 156 and Pigment Yellow 175; Pigment Green 1, Pigment Green 7, Pigment Green 10 and Pigment Green 36; Pigment Orange 5, Pigment Orange 15, Pigment Orange 16, Pigment Orange 31, Pigment Orange 34, Pigment Orange 36, Pigment Orange 43, Pigment Orange 48, Pigment Orange 51, Pigment Orange 60 and Pigment Orange 61; Pigment Red 4, Pigment Red 5, Pigment Red 7, Pigment Red 9, Pigment Red 22, Pigment Red 23, Pigment Red 48, Pigment Red 48:2, Pigment Red 49, Pigment Red 112, Pigment Red 122, Pigment Red 123, Pigment Red 149, Pigment Red 166, Pigment Red 168, Pigment Red 170, Pigment Red 177, Pigment Red 179, Pigment Red 190, Pigment Red 202, Pigment Red 206, Pigment Red 207 and Pigment Red 224; Pigment Violet 19, Pigment Violet 23, Pigment Violet 37, Pigment Violet 32 and Pigment Violet 42; and Pigment Black 6 and Pigment Black 7.

Mixtures of colorants may be employed, if desired, including mixtures of dyes, mixtures of pigments and mixtures of one or more dyes with one or more pigments.

Preferred pigments include Pigment Blue 15:3, Pigment Blue 15:4, Pigment Yellow 155, Pigment Red 122, and a complex of Pigment Red 202 and Pigment Violet 19.

Useful pigment particle size is typically in the range of from about 0.005 micron to about 15 micron. Preferably, the pigment particle size should range from about 0.005 to about 5 micron, more preferably from about 0.005 to about 1 micron, and most preferably from about 0.005 to about 0.3 micron.

Other Components

Additives (components other than vehicle and colorant) may be present in the ink to improve the properties or performance. Additives may be, for example, surfactants (other than as mentioned above), defoamers, photoinitiators, photosynergists, stabilizers against deterioration by heat or light, deodorants, flow or slip aids, biocides and identifying tracers.

The radiation curable inks of the present invention preferably include photoinitators, photosynergists and photosensitizers.

Examples of radical photoinitiators include 2,2-dimethyl-2-hydroxy-acetophenone; 1-hydroxy-1-cyclohexyl-phenyl ketone; 2,2-dimethoxy-2-phenylacetophenone; 2,4,6-trimethylbenzyl-diphenyl-phosphine oxide; Benzophenone; blends of bis(2,6-dimethoxybenzoyl)-2,4,4-trimethyl pentyl phosphine oxide and 1-phenyl-2-hydroxy-2-methyl propanone; blends of bis(2,6-dimethoxybenzoyl)-2,4,4-trimethyl pentyl phosphine oxide and 1-hydroxycyclohexyl-phenyl ketone; bis(2,4, 6-trimethylbenzoyl)phenylphosphine oxide; and camphorquinone. Examples of cationic photoinitiators include iodonium and sulfonium salts. Preferred photoinitators include 2-benzyl-2-dimethylamino-1-(4-morpholinophenyl)-butan 1-one, and/or 2-methyl-1-(4-(methylthio)phenyl)-2-morpholino-propan-1-one.

Examples of photoactivators and photosynergists include ethyl-4-(dimethylamino)benzoate, N-methyldiethanolamine and 2-ethylhexyldimethylaminobenzoate. Such materials will generally be required only for free-radical curing. 1-chloro-4-propoxythioxanthone and isopropyl thioxanthone (mixture of 2- and 4-isomers) have been used as sensitizers for α-amino acetophenones.

Proportions of Ingredients

The components described above can be combined to make an ink in various proportions and combinations in order to achieve desired ink properties, as generally described above, and as generally recognized by those of ordinary skill in the art. Some experimentation may be necessary to optimize inks for a particular end use, but such optimization is generally within the ordinary skill in the art.

For example, the amount of vehicle in an ink is typically in the range of about 70% to about 99.8%, and preferably about 80% to about 98.0%, by weight based on total weight of the ink.

In a colored ink, colorant will generally be present in amounts up to about 12%, and more typically in the range of about 1% to about 9%, by weight based on total weight of the ink.

The amount of dispersant employed (or dispersant and synergist where used) will depend upon the choice and concentration of the pigment, and is typically based on the amount of colorant. Dispersants can be employed at a pigment-to-dispersant weight ratio in the range of about 1:3 to about 4:1. For organic pigments, the amount will usually be in the range of from about.15 to about 100% by weight, and preferably from about 20 to about 75% by weight, based on the weight of the pigment. For inorganic pigments, lower concentrations may be acceptable, e.g. about 5% or less.

Other ingredients (additives), when present, generally comprise less than about 15% by weight, based on the total weight of the ink.

When surfactants, defoamers, photoinitiators, photosynergists, stabilizers against deterioration by heat or light, deodorants, flow or slip aids, biocides and identifying tracers are used, these additives are individually present in amounts typically in a range of from about 0.01 wt % to about 6 wt %, based on the total weight of the ink.

Ink Properties

Jet velocity, separation length of the droplets, drop size, and stream stability are greatly affected by the surface tension and the viscosity of the ink. The surface tension will typically be in the range of about 15 dyne/cm to about 50 dyne/cm and more typically in the range 15 dyne/cm to about 35 dyne/cm. Viscosities are typically no greater than 30 cP, and more typically in the range of about 3.0 cP to about 20.0 cP at printhead operating temperature. The physical properties are compatible with a wide range of ejecting conditions, i.e., driving voltage, frequency and pulse width of ink jet printing device, and the shape and size of the nozzle. The inks have excellent storage stability for a long period and do not clog in an ink jet apparatus. They are useful with a variety of printheads, but are especially useful for piezo and similar printheads.

Ink Sets

The term “ink set” refers to all the individual fluids an inkjet printer is equipped to jet. For color printing an ink set will typically include at least a cyan, magenta and yellow ink. Commonly a black ink is also included. In addition to the typical CMY(K) inks, ink sets may further comprise one or more “gamut-expanding” inks, including different colored inks such as an orange ink, a green ink, a red ink, a violet ink and/or a blue ink, and combinations of full strength and light strengths inks such as light cyan and light magenta.

Substrates

The inks may be employed for printing on to a wide variety of substrates, both absorbent and non-absorbent including paper, glass, plastic and metal, e.g. steel, copper and aluminum, but are particularly suitable for printing on to plastics to provide a strongly bonded print of good definition and optical density. The plastic can, but need not, be pre-treated, for example by flame, plasma etch or corona treatment to raise the surface energy. Plastic substrate can be in the form of a film including but not limited to single and multi-layer constructions of acrylic-containing films, polyvinylchloride-containing films, (inncluding vinyl, plasticized vinyl, reinforced vinyl, vinyl/acrylic blends), urethane-containing films, melamine-containing films, polyvinylfluoride-containing films and polyvinylbutyral-containing films.

Printing Method and Post Treatment

The inks of the present invention can be applied with any suitable printer, many of which are available commercially. Examples of commercial UV printers include those available from the following vendors: DuPont (“CromaPrint 22UV”), Vutek (“PressVu” series of printers), Durst (“Rho” series of printers), Nur (“Tempo”), Leggett & Platt (“Virtu” series of printers), and Sericol/Inca Digital (“Columbia”, “Eagle” and “Spyder” series of printers). These printers include, or make available, suitable UV light sources to cure the printed inks.

### EXAMPLES

The invention will now be further illustrated by, but not limited to, the following examples. Ingredient amounts are listed as weight percent of the total weight of concentrate or ink, unless otherwise noted. The chemical identity of commercial ingredients is as follows.

| Tradename or Abbreviation | Identity |
|---|---|
| ¹Solsperse ™ 39000 | Polymeric Dispersant |
| ¹Solsperse ™ 5000 | Pigmentary synergist |
| ¹Solsperse ™ 22000 | Pigmentary synergist |
| ³Photomer ® 4361 | Ethoxylated (2)-1,6-hexanediol diacrylate, |
| | (2 moles average ethoxylation) |
| ⁴SR 492 | Propoxylated trimethylolpropane triacrylate |
| | (3 moles average propoxylation) |
| ⁵ODA-N | n-Octyl acrylate, n-decyl acrylate mixture |
| ²Irgacure ® 907 | 2-methyl-1-[4-(methylthio)phenyl]-2-(4- |
| | morpholinyl)-1-propanone |
| ²Irgacure ® 369 | 2-Benzyl-2-(dimethylamino)-1-[4-(4- |
| | morpholinyl)phenyl]-1-butanone |
| ⁴ITX | Isopropylthioxanthone |
| ⁴EDB | Ethyl-p-N,N-dimethylamino benzoate |
| ⁶Zonyl ® FSO-100 | Nonionic fluoro surfactant |
| ⁷Dynol ™ 604 | Acetylenic diol surfactant |
| ⁷Surfynol ® 104 | Acetylenic diol surfactant |
| ⁸BYK ® 348 | Silicone surfactant |

¹Noveon, Inc. (Charlotte, NC, USA).
²Ciba Specialty Chemicals (Newport, DE, USA)
³Cognis Corporation (Ambler, PA, USA)
⁴Sartomer Company (Exton, PA, USA)
⁵Cytec Industries Inc. (West Paterson, NJ, USA)
⁶E. I. du Pont de Nemours and Company (Wilmington, DE, USA)
⁷Air Products and Chemicals (Allentown, PA, USA)
⁸Byk Chemie USA (Wallingford, CT., USA)

Preparation of Dispersions

A cyan pigment dispersion concentrate with the following composition was prepared by milling ingredients in a bead mill using 0.8 mm YTZ media.

| Cyan dispersion concentrate | Weight % |
|---|---|
| Photomer ® 4361 | 69.97% |
| 4-methoxylphenol | 0.03% |
| Solsperse ™ 39000 | 10.00% |
| Pigment Blue 15:4 | 20% |

Preparation of Inks

The ink formulations in the examples were prepared by mixing together the pigment concentrate described above with appropriate vehicle and other components.

Evaluation of Print Appearance

To evaluate appearance, a print was inspected under low (10×) magnification and with the unaided eye. The following rating scale was applied.
Poor—little ink coalescence, rough surface, much white space apparent giving a mottled appearance. (undesirable image quality).
Fair—slightly improved ink coalescence and less surface roughness, but some white space apparent giving a mottled appearance. (better but still undesirable image quality).
Good—even coverage, smooth surface, little or no white space apparent and little or no mottling evident. (acceptable image quality).
Excellent—fully coalesced ink film, very smooth surface, no white space evident. (very desirable image quality).
   Viscosity

Viscosity was measured with a Brookfield Viscometer LVDV2+ using Spindle 00 and a UL Adapter with temperature control at 25° C. and at 35° C. Results are reported in cP.

Surface Tension

Surface tension was measured with a Kruss Surface Tensiometer (Wilhelmy Plate Method) at ambient temperature. Results are reported in dynes/cm.

### Example 1

Inks 1a-1f with varying levels and ratios of fluoro surfactant (Zonyl® FSO-100) and acetylene diol surfactant (Surfynol® 104), as shown in the following table, were prepared and jetted with a CromaPrint 22UV (E. I. du Pont de Nemours and Company, Wilimington, Del., USA). The printhead was heated to about 40° C.; the drop size was about 30 ng; the print mode was 600 by 800 dpi, and the pattern was a solid block at 100% coverage. The substrates were PVC (polyvinyl chloride) board, adhesive backed vinyl film (Avery Corp.) and polycarbonate sheet.

Results showed that the prescribed surfactant blend provided good to excellent appearance across the range of substrates tested. In this formulation, it was most advantageous for the fluoro surfactant to be present at levels of at least about 1.5 weight percent, and the acetylenic diol to be present at levels of at least about 0.5 weight percent.

In actual practice, the ratio and level of surfactant needed for optimum performance may vary depending on the particular formulation. Routine experimentation will reveal the most appropriate levels. In some cases, surfactant levels in substantial excess of what is needed for proper spreading can be detrimental to image quality and durability.

The pigment and dispersant in each case was the cyan pigment and dispersant from the cyan dispersion concentrate above. The Ink 1f formulation was also used to prepare magenta, yellow and black inks using a magenta, yellow and black concentrate in place of the cyan. Similar excellent appearance was obtained for these other colors as well.

| | Ink 1a | Ink 1b | Ink 1c | Ink 1d | Ink 1e | Ink 1f |
|---|---|---|---|---|---|---|
| Ingredients | | | | | | |
| Cyan Pigment | 2.0 | 2.0 | 2.0 | 2.0 | 2.0 | 2.0 |
| Solsperse ™ 39000 | 1.0 | 1.0 | 1.0 | 1.0 | 1.0 | 1.0 |
| Photomer ® 4361 | 61.5 | 61.0 | 60.5 | 61.0 | 60.5 | 60.0 |
| ODA-N | 15.0 | 15.0 | 15.0 | 15.0 | 15.0 | 15.0 |
| SR 492 | 10.0 | 10.0 | 10.0 | 10.0 | 10.0 | 10.0 |
| Irgacure ® 369 | 5.0 | 5.0 | 5.0 | 5.0 | 5.0 | 5.0 |
| EDB | 3.0 | 3.0 | 3.0 | 3.0 | 3.0 | 3.0 |
| ITX | 1.0 | 1.0 | 1.0 | 1.0 | 1.0 | 1.0 |
| Zonyl ® FSO-100 | 1.0 | 1.5 | 2.0 | 1.0 | 1.5 | 2.0 |
| Surfynol ® 104 | 0.5 | 0.5 | 0.5 | 1.0 | 1.0 | 1.0 |
| Physical Properties | | | | | | |
| Surface tension | 27.4 | 23.5 | 23.1 | 25.6 | 23.4 | 22.8 |
| Viscosity | 13.4 | 13.2 | 13.5 | 13.7 | 13.1 | 13.4 |
| 30 rpm@35° C. | | | | | | |
| Appearance | | | | | | |
| PVC Board | Fair | Good | Good | Good | Good | Excellent |
| Avery Vinyl | Fair | Fair | Fair | Fair | Good | Excellent |
| Polycarbonate | Excellent | Excellent | Excellent | Excellent | Excellent | Excellent |

### Example 2

Inks 2a-2c, shown in the following table, were prepared and printed in the same manner as the previous example. This demonstrated the use of a different acetylenic diol surfactant (Dynol™ 604) in combination with a fluoro surfactant also gave good results over a range of substrates.

| | Ink 2a | Ink 2b | Ink 2c |
|---|---|---|---|
| Ingredients | | | |
| Cyan Pigment | 2.0 | 2.0 | 2.0 |
| Solsperse ™ 39000 | 1.0 | 1.0 | 1.0 |
| Photomer ® 4361 | 61.0 | 60.5 | 60.0 |
| ODA-N | 15.0 | 15.0 | 15.0 |
| SR 492 | 10.0 | 10.0 | 10.0 |
| Irgacure ® 369 | 5.0 | 5.0 | 5.0 |
| EDB | 3.0 | 3.0 | 3.0 |
| ITX | 1.0 | 1.0 | 1.0 |
| Zonyl ® FSO-100 | 1.0 | 1.5 | 2.0 |
| Dynol ™ 604 | 1.0 | 1.0 | 1.0 |
| Physical Properties | | | |
| Surface tension | 26.22 | 25.59 | 23.83 |
| Viscosity | 13.6 | 13.4 | 13.5 |
| 30 rpm@35° C. | | | |
| Appearance | | | |
| PVC Board | Poor | Fair | Good |
| Avery Vinyl | Poor | Fair | Good |
| Polycarbonate | Fair | Good | Excellent |

### Example 3 (Comparative)

Comparative inks 3a-3d, shown in the following table, were prepared and printed in the same manner as Example 1. Inks with fluoro (3a), acetylenic diol (3b) and silicone (3c) surfactant alone do not provide good appearance across the range of substrates tested. Likewise, a mixture of fluoro and silicone surfactant (3d) is not effective and neither is a commercial Sericol UVIJET cyan ink sample.

| | Ink 4a | Ink 4b | Ink 4c | Ink 4d | UVIJET |
|---|---|---|---|---|---|
| | (comp.) | (comp.) | (comp.) | (comp.) | cyan |
| Ingredients | | | | | |
| Cyan Pigment | 2.0 | 2.0 | 2.0 | 2.0 | |
| Solsperse ™ 39000 | 1.0 | 1.0 | 1.0 | 1.0 | |
| Photomer ® 4361 | 61.0 | 62.5 | 62.0 | 60.0 | |
| ODA-N | 15.0 | 15.0 | 15.0 | 15.0 | |
| SR 492 | 10.0 | 10.0 | 10.0 | 10.0 | |
| Irgacure ® 369 | 5.0 | 5.0 | 5.0 | 5.0 | |
| EDB | 3.0 | 3.0 | 3.0 | 3.0 | |
| ITX | 1.0 | 1.0 | 1.0 | 1.0 | |
| Zonyl ® FSO-100 | 2.0 | — | 0.0 | 2.0 | |
| BYK ® 348 | — | 0.5 | — | 1.0 | |
| Surfynol ® 104 | — | — | 1.0 | — | |
| Physical Properties | | | | | |
| Surface tension | 24.3 | 33.4 | 33.23 | 23.0 | 24.8 |
| Viscosity | 13.1 | 12.8 | 13.5 | 12.9 | 15.4 |
| 30 rpm@35° C. | | | | | |
| Appearance | | | | | |
| PVC Board | Poor | Poor | Poor | Excellent | Poor |
| Avery Vinyl | Poor | Poor | Poor | Poor | N/a |
| Polycarbonate | Excel- | Excel- | Excellent | good | Poor |
| | lent | lent | | | |

1. A radiation curable inkjet ink composition comprising a polymerizable vehicle and a surfactant mixture, wherein the surfactant mixture comprises at least one fluorinated surfactant and at least one acetylenic diol surfactant.

2. The radiation curable inkjet ink composition of claim 1, wherein the fluorinated surfactant is present in an amount of from about 0.1% to about 4.0% by weight, and the acetylenic diol surfactant is present in an amount of from about 0.1% to about 4.0% by weight, based on total ink weight.

3. The radiation curable inkjet ink composition of any one or all of the previous claims, wherein the fluorinated surfactant is represented by the formula:
(R(f)Q)ₙA
wherein R(f) is a perfluoroalkyl group having 6 to 22 carbon atoms, Q is a divalent bridging group, A is a water-soluble group, and n is 1 or 2.

4. The radiation curable inkjet ink composition of any one or all of the previous claims, wherein the at least one fluorinated surfactant is nonionic.

5. The radiation curable inkjet ink composition of any one or all of the previous claims, wherein the acetylenic diol surfactant is represented by the following structure: 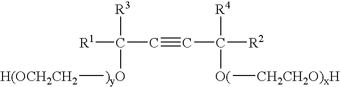
wherein R¹ are R² are independently branched or linear alkyls having 3 to 12 carbons, R³are R⁴ are independently hydrogen or methyl, x and y are integers, and x+y is 0 to about 16.

6. The radiation curable inkjet ink composition of claim 4, wherein the acetylenic diol surfactant is represented by the following structure:

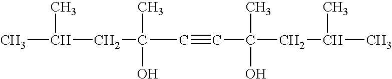

7. The radiation curable inkjet ink composition of any one or all of the previous claims, wherein polymerizable vehicle comprises a mixture mono-functional and multi-functional polymerizable monomers.

8. The radiation curable inkjet ink composition of claim 6, wherein the total of all mono-functional and multi-functional polymerizable monomers amounts to at least about 65% by weight of the total weight of ink.

9. The radiation curable inkjet ink composition of claim 7 or claim 8, wherein:
the polymerizable mono-functional monomer is selected from the group consisting of n-octyl-acrylate, n-nonyl acrylate, n-decyl acrylate and combinations thereof; and
the multi-functional polymerizable monomer is selected from the group consisting of ethoxylated 1,6-hexanediol diacrylate, propoxylated trimethylolpropane triacrylate and combinations thereof.

10. A method for ink jet printing onto a substrate, comprising the steps of:
(a) providing an ink jet printer that is responsive to digital data signals;
(b) loading the printer with a substrate to be printed;
(c) loading the printer with a radiation curable inkjet ink or inkjet ink set as set forth in any one or all of the previous claims; and
(d) printing onto the substrate using said inkjet ink or inkjet ink set, in response to the digital data signals, and forming thereby a printed article.

11. The method of claim 10, wherein the substrate is selected from the group, paper, glass, plastic, metal and wood.

12. The method of claim 10, further comprising the step of exposing the printed article to radiation suitable for curing the ink printed thereon.

13. The method of claim 12, wherein the radiation is ultraviolet light.

14. The method of claim 11, wherein the substrate is a plastic selected from the group consisting of polyvinyl chloride, polyvinyl fluoride, polyvinyl butyral, polycarbonate and polyurethane.
